(19) United States
(12) Patent Application Publication
(10) Pub. No.: US 2013/0146193 A1
(43) Pub. Date: Jun. 13, 2013

(54) TIRE PRESSURE EQUALIZATION SYSTEM

(71) Applicant: Thomas Greenshields STEPHENSON, Houston, TX (US)

(72) Inventor: Thomas Greenshields STEPHENSON, Houston, TX (US)

(73) Assignee: HSM Tire Company, Houston, TX (US)

(21) Appl. No.: 13/316,889

(22) Filed: Dec. 12, 2011

(51) Int. Cl. B60C 29/06; F16K 15/20

(52) U.S. Cl. 152/415; 137/224

(57) ABSTRACT

A tire pressure equalization system for controlling air pressure between a first tire and a second tire has a housing with a bore extending therethrough, a first air passageway with an end opening to an interior of the bore, a second air passageway with an end opening to an interior of the bore, and a valve positioned in the bore. The first air passageway is connected to the first tire. The second air passageway is connected to the second tire. The valve is movable between a first position in which the first air passageway communicates with the second air passageway so as to allow the air to equalize between the first and second tires and a second position that blocks communication between the first air passageway and the second air passageway so as to prevent air from flowing between the first tire and the second tire.

### CROSS-REFERENCE TO RELATED APPLICATIONS

Not applicable.

### STATEMENT REGARDING FEDERALLY SPONSORED RESEARCH OR DEVELOPMENT

Not applicable.

### NAMES OF THE PARTIES TO A JOINT RESEARCH AGREEMENT

Not applicable.

### INCORPORATION-BY-REFERENCE OF MATERIALS SUBMITTED ON A COMPACT DISC

Not applicable.

### BACKGROUND OF THE INVENTION

1. Field of the Invention

The present invention relates to pressure balancing systems between a set of dual tires on vehicles. More particularly, the present invention the relates to a valve arrangement for controlling the air pressure between such dual tires. Additionally, the present invention relates to tire pressure equalization systems which serve to maintain equal pressure between the dual tires and for blocking the release of air pressure in the event of deflation of one of the dual tires.

2. Description of Related Art Including Information Disclosed Under 37 CFR 1.97 and 37 CFR 1.98

Load hauling trucks, earthmoving equipment, and the like are often propelled by sets of dual tires. Machines of this nature typically have a set of dual tires mounted on each end of an axle. Each set of dual tires includes an inner tire and an outer tire. Each tire is mounted on a separate rim. The inner rim and tire are attached to an indboard end of the wheel assembly and the outer rim and tire are attached to an outboard end of the wheel assembly. The wheel assembly rotates about an axle via a pair of wheel bearings. One of the wheel bearings is located near the indboard end of the wheel assembly and other is located near the outboard end of the wheel assembly. The wheel bearings are designed and positioned on the axle to carry a predetermined portion of the load (gross weight) of the machine. The load is then transferred through the tires to the ground. During normal operation of the machine, the air pressure in the inner and outer tires may not be equal. This can be caused by an improper inflation, uneven heating of the tires, uneven forces bearing upon the tires during operation, or an air leak in either of the tires.

Unbalanced or improper air pressure between the inner and outer tires can cause a portion of the load on either wheel bearing to shift from one bearing to the other. These unbalanced loads can cause excessive wear on one or each of the tires or improper loading on one or each of the wheel bearings. Repeated excessive loading may cause permanent damage to the bearings.

It is possible that each of the tires could be connected together by a hose or a tube passageway so as to allow for equalization of air pressure. However, a sudden loss of pressure in either tire would result in loss of pressure in both tires. As such, it is desirable that, in the event of deflation of one of the tires, that air is prevented from flowing between the inflated tire to the deflated tire, thus causing a deflation of both of the tires.

One particular application of such co-axial tires is heavy dump or haul trucks. In particular, FIG. 1 illustrates a truck 10 having a first set 12 of tires on one side of the vehicle and a second set 14 of tires on an opposite side of the vehicle. It can be seen that the first set of tires includes an outboard tire 16 and an inboard tire 18. Similarly, the second set 14 of tires includes an outboard tire 20 and an inboard tire 22. An axle 24 is utilized so as to connect the tires such that the tires rotate correspondingly. The truck 10 is of a type used during numerous applications, including mining. These trucks are often referred to as “off-road” vehicles in that they are applied to non-road applications.

For example, mine haul trucks carry significant loads. It is not uncommon for these loads to be in excess of 150 tons. As a result, the first set 12 of tires and the second set 14 of tires are used so as to distribute the load. These tires that are utilized are tubeless and large. Generally, the wheels are in excess of nine feet in diameter. They also operate under extreme conditions and can be in constant use. As a result, the tires are prone in carrying debris and particulate matter, such as rust or rocks.

Due to the significant loads carried by the vehicle 10, any pressure imbalance in the co-axial tires can cause significant problems. For instance, where a pair of co-axial tires are of pressures between 80 p.s.i. and over 100 p.s.i., there is a significant imbalance in the respective load and therefore how each tire performs. In this situation, with a total load of 110 tons, 42 tons would be distributed on the tire having a 80 p.s.i. of pressure and 72 tons on the tire having over 100 p.s.i. Therefore, one of the tires is working almost twice as hard as the other tire. The air flow caused by this imbalance results in an increase in tire temperature. This can dramatically increase wear and tear on the tires. In the worst case, the temperature may reach the liquefaction temperature of the tire rubber. If this occurs, the tire can be irreparably damaged and must be replaced.

These large tires for the mine or haul trucks are very scarce. The tires are of significant cost, commonly in excess of $75,000 each. Therefore, any improvement in the life of such a tire is advantageous.

In the past, a verity of patents have relating to tire pressure equalization system and systems for monitoring such tire pressure. For example, U.S. Pat. No. 2,445,547, issued on Jul. 20, 1948 to H. N. Wheeler, is an early patent relating to a dual tire valve. This pressure equalization device includes a valve body, a pair of aligned valve cappings having opposed seats communicating with the body and a single valve member. The valves carried by the member are adapted to coact with the seats and are disposed such that only one valve may be seated at a time. There is a means to admit air between the valves. A means is responsive to the admission of air between the valves so as to hold both of the valves off their seats.

U.S. Pat. No. 3,302,682, issued on Feb. 7, 1967 to A. A. Berg, shows a tire pressure device that has an elongated tubular housing, a chamber at one end of the housing, a filler opening communicating with the chamber, a pair of spaced outlets communicating with the chamber, a second chamber in the housing, a piston receptacle in the second chamber, and a passage communicating between the chambers on one side of the piston. A yielding means is on the other side of the piston and engages the piston so as to urge the piston toward the passage. A hollow cylindrical member substantially fills the second chamber. This cylindrical member slidably receives the piston. The housing has an opening overlying a portion of the cylindrical member. A plurality of annular flanges are spaced longitudally on the shaft and engage the inner surface of the cylindrical member so as to center and guide the shaft.

U.S. Pat. No. 3,454,034, issued on Jul. 8, 1969 to H. L. Dobrikin, shows a pressure system for a dual tire set that is operable to maintain a pressure balance between the tires above a predetermined minimum pressure. A valve housing is provided with a plenum chamber having a plunger slidable therein. The plunger has a bore extending axially therethough with a tire filling valve in one end and radially extending ports in the other end. A ball member is movably positioned in the bore to coact with the bore and ports for relatively quick inflation and slow deflation of the tire. An exhaust passage is provided in the housing and is controlled by a biased open exhaust valve which is moved to a closed position by engagement therewith of the plunger at temperatures above a predetermined minimum. Passages are provided in the housing so as to communicate the plenum chamber with the tires. Conduits connect the passages with the tires. These conduits each have a protection valve therein which maintains its associated tire valve by engagement therewith so long as pressure in the system is above a predetermined minimum but move out of engagement with its associated tire valve allowing the valve to close when the pressure in the system falls below the minimum. This disrupts communication between the tires. At pressures below the minimum, the exhaust valve is opened by its biasing means so as to establish atomospheric pressure and the plenum chamber.

U.S. Pat. No. 3,717,030, issued on Feb. 20, 1973 to McGhee et al., shows a tire pressure indicating apparatus for monitoring tire pressures on a vehicle. Individual hub units are mounted on each wheel unit. The hub units include a radio transmitter which is positioned by the vehicle operator. For dual wheel units used on heavy-duty vehicles, a common bellows responds to the lower pressure of the two tires to indicate the lower pressure on the gauge and transmit the fault signal. The dual wheel unit can include a pair of bellows means for actuating separate visual gauges for the two tires. The two bellows mechanisms energize a common transmitter. The hub unit can include valve for equalizing tire pressures.

U.S. Pat. No. 4,421,151, issued on Dec. 20, 1983 to W. Stumpe, describes a tire-pressure regulating system in which the air pressure in the vehicle tires can be varied while driving. The tires are connected to supply lines in which rotor connections, control valves, flow restrictive elements and an adjustable regulating valve are disposed. A relay valve and an axle valve are incorporated following the regulating valve. An acceleration of the tire equalization process occurs by guiding the supply line in and at the axle valve in a particular manner.

U.S. Pat. No. 4,658,644, issued on Apr. 21, 1987 to Coesfeld et al., teaches a manometer device for continuous monitoring of the air pressure in vehicle tires. This device includes manometric capsule and an electrical indicator device. A flatly conical membrane with a cylindrical projection is arranged transversely through the interior space of the manometric capsule. A permanent magnet is inserted in this projection. The membrane divides the interior space of the manometric capsule into two chambers. One chamber is stressed with a nominal pressure. The other chamber is connected to the pressure space of a vehicle tire. A stationary sensor, which is associated with the manometric capsule, responds to linear magnetic field variations and transmits the latter to a terminal.

U.S. Pat. No. 5,253,687, issued on Oct. 19, 1993 to Beverly et al., shows a vehicle central tire inflation system. The system includes an air control circuit having a positive pressure air source, a vacuum pressure air source, a central control unit, a vehicle speed sensor, and a command/display console. The control circuit includes valves and a conduit assembly for controlling communication of the positive and vacuum pressure to the wheel valve assemblies mounted on each wheel. A vent valve effects rapid closing of a valve device in each wheel valve. Each wheel valve includes a valve device providing substantially unrestricted air flow from the conduit assembly to the wheels when the valve device is open and provides restricted air flow from the wheels to the conduit assembly to ensure closing of the valve device when the conduit is vented.

U.S. Pat. No. 5,302,939, issued on Apr. 12, 1994 to Downs et al., provides a dual tire equalizer having remote indicator. In particular, the dual tire equalizer has a diaphragm with an axial probe actuating or not actuating a switch in a radio frequency transmitter circuit mounted on the wheel. The transmitter sends a signal varying, depending on the condition of the switch. A radio frequency receiver on the vehicle responds to the signal and issues appropriate information to the driver concerning conditions of the equalizer.

U.S. Pat. No. 5,307,846 issued on May 3, 1994 to Heinemann, describes a tire pressure equalizer which gives motorists a simple, low-cost way to adjust and balance the pressure within the individual tires of the vehicle without accidentally exceeding the maximum pressure level of the tires. The apparatus interconnects the four tires. A pressure gauge and a conventional tire air valve permit the internal air pressure of all four tires to be adjusted uniformly from one air source through a commercial connector and a specially-designed shut-off valve and to be disconnected without a loss of air in any of the four tires. If a pre-set air pressure level has been exceeded while air is being pumped into the tires, a safety air pressure-relief valve, coupled to a whistle, is triggered so as to notifying the motorist of this condition.

U.S. Pat. No. 6,457,502, issued on Oct. 1, 2002 to Bell et al., discloses a dual tire pressure balance system for maintaining equal air pressure in a pair of tires on a work machine. This system has a valve body with a pair of piston chambers. A piston is reciprocatably positioned within each piston chamber. The pistons are biased toward a first closed end of the piston chambers. The closed end of each piston chamber is connected by a passageway to one of the tires. Each piston chamber is additionally fluidly connected to the other piston chamber. When the air pressure in each tire is above a predetermined amount, the pistons are moved away from the closed end of the piston chamber and air flow is permitted between the piston chambers thereby balancing the tire pressures. If the pressure in either tire is below the predetermined minimum, the piston in that respective piston chamber moves toward the first end to block, airflow between the piston chambers.

U.S. Pat. No. 7,555,903, issued on Jul. 7, 2009 to Tarasinski et al., teaches a tire pressure regulating systems for regulating the pressure of tires mounted on a vehicle. The vehicle has an engine with a turbocharger which is a compressed air source for the pressure regulating system. The turbocharger has a variable geometry in order to supply a sufficiently high pressure.

It is an object of the present invention to provide a system which effectively balances air pressure between dual tires.

It is another object of the present invention to provide a system which blocks air flow in the event of deflation of one of the tires of the dual tire system.

It is another object of the present invention to provide a system whereby pressure between a pair of tires in a dual tire system remains constant regardless of the force or temperature affecting one of the tires.

It is still a further object of the present invention to provide a system which can be retrofitted to a dual tire system.

These and other objects and advantages of the present invention will become apparent from a reading of the attached specification and appended claims.

### BRIEF SUMMARY OF THE INVENTION

The present invention is a tire pressure equalization system for controlling air pressure between a first tire and a second tire. This system includes a housing having a bore extending therein. A first air passageway has an end opening to an interior of the bore. The first air passageway is suitable for connection to the first tire. A second air passageway has an end opening to an interior of the bore. The second air passageway is suitable for connection to the second tire. A valve is in the bore. The valve is movable between a first position in which the first air passageway communicates with the second air passageway in the bore and a second position that blocks communication between the first air passageway and the second air passageway.

In the preferred embodiment of the present invention, the valve is slidably positioned in the bore. In particular, in this preferred embodiment of the present invention, the valve is a shuttle valve having a wide diameter portion and a narrow diameter portion. The wide diameter portion is positioned against a wall of the bore. The narrow diameter portion is aligned with the first and second air passageways in the first position. The wide diameter portion is aligned with at least one of the first and second air passageways in the second position.

Also, in the preferred embodiment of the present invention, the housing has a first cylindrical area at one end of the bore and a second cylindrical area at an opposite end of the bore. The valve has a first rod extending through the first cylindrical area and a second rod extending through the second cylindrical area. A first piston is affixed to the first rod and has a periphery adjacent a wall of the first cylindrical area. A second piston is affixed to the second rod and has a periphery adjacent a wall of the second cylindrical area. The first cylindrical area has a shoulder adjacent to the bore. The second cylindrical area also has a shoulder adjacent the bore. A first spring has one end bearing against the first piston and an opposite end bearing against the shoulder of the first cylindrical area. A second spring has one end bearing against the second piston and an opposite end bearing against the shoulder of the second cylindrical area.

Also, in the preferred embodiment of the present invention, a third air passageway has an end opening to an interior of the first cylindrical area on a side of the first piston opposite the valve. The third air passageway is suitable for connection to the first tire. A fourth air passageway has an end opening to an interior of the first cylindrical area on a side of the piston opposite the third air passageway. The fourth air passageway is suitable for connection to the second tire. A fifth air passageway has an end opening to an interior of the second cylindrical area on a side of the second piston opposite the valve. The fifth air passageway is suitable for connection to the second tire. A sixth air passageway has an end opening to an interior of the second cylindrical area on a side of the second piston opposite the first air passageway. The sixth air passageway is suitable for connection to the first tire.

In the preferred embodiment of the present invention, a first air channel has one end opening on one side of the housing and an opposite end suitable for connection to the first tire. A second air channel has one end opening on one side of the housing and an opposite end suitable for connection to the second tire. A third air channel opens on the one side of the housing. The third air channel is in communication with the first air channel and the second air channel. A first one-way valve is positioned on the first air channel so as to allow air to pass through the first air channel to the first tire and for preventing air from passing from the first tire. A second one-way valve is positioned in the second air channel so as to allow air to pass through the second air channel to the second tire and for preventing air from passing from the second tire. A first air pressure sensor is cooperative with the first air channel so as to sense air pressure in the first tire. A second air pressure sensor is cooperative with the second air channel so as to sense air pressure in the second tire.

In this section, although the preferred embodiment is described with specificity, it is important that various other embodiments of the present invention can be made within the scope of the present invention. As such, such statements under this section should not be construed as, in any way, limiting of the scope of the present invention. Quite clearly, variations on the particular details of the structure identified under this section can be made within the scope of the present invention without departing from that which is claimed.

### BRIEF DESCRIPTION OF THE SEVERAL VIEWS OF THE DRAWINGS

FIG. 1 is an end view of a prior art truck that utilizes the dual arrangement to which the present invention is applied.

FIG. 2 is a detailed view of a dual arrangement in which the tire pressure equalization is employed.

FIG. 3 is a perspective view of the structure of the tire pressure equalization system in accordance with the preferred embodiment of the present invention.

FIG. 4 is a transparent perspective view of the tire pressure equalization system of the present invention.

FIG. 5 is an opposite side transparent perspective view showing the tire pressure equalization system of the present invention.

FIG. 6 is a diagrammatic illustration of the various flow passageways associated with the tire pressure equalization system of the present invention.

FIG. 7 is a diagrammatic illustration of the air channels associated with the tire pressure equalization system of the present invention for the simultaneous filling of both tires of a dual tire arrangement.

FIG. 8 is a diagrammatic illustration of the tire pressure equalization system of the present invention showing the use of an air channel for the filling of a single tire.

FIG. 9 is a diagrammatic illustration of the tire pressure equalization system of the present invention showing, in particular, the use of an air channel for the filling of a single tire.

FIG. 10 is a diagrammatic illustration of the tire pressure equalization system of the present invention with the valve in a first position so as to allow pressure between the tires to be equalized.

FIG. 11 is a diagrammatic illustration of the tire pressure equalization system of the present invention in which air flow to one of the tires is effectively blocked.

FIG. 12 is a diagrammatic illustration of the tire pressure equalization system of the present invention in which air flow to the other tire is effectively blocked.

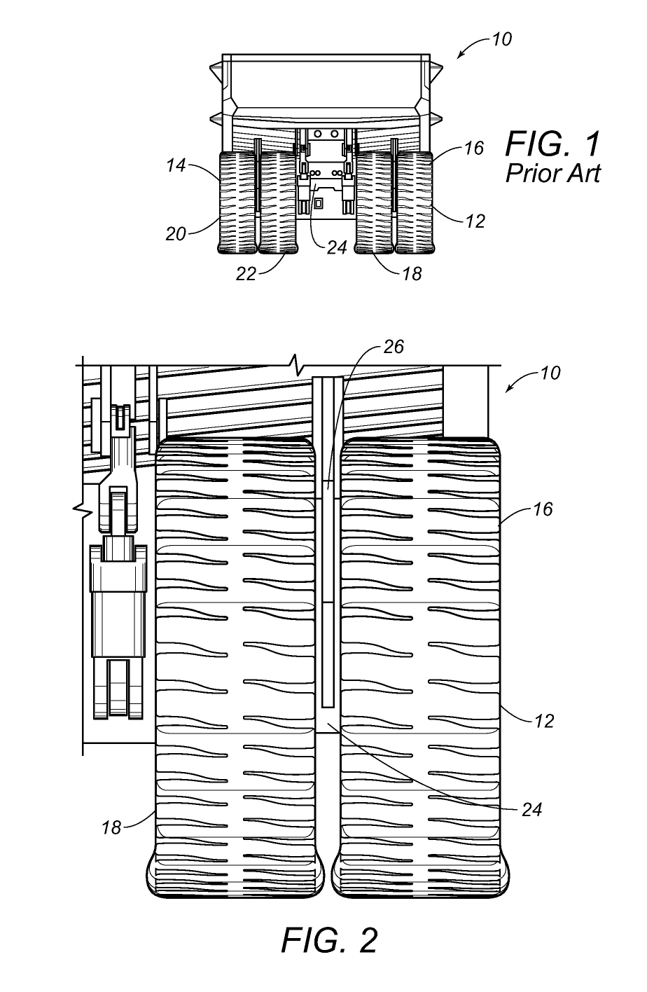

### DETAILED DESCRIPTION OF THE INVENTION

Referring to FIG. 2, there is shown the truck 10 to which the dual tire arrangement 12 is applied. It can be seen that the outboard tire 16 and the inboard tire 18 are support coaxially upon axle 24. As such, tires 16 and 18 are mounted together so as to rotate correspondingly. The tire pressure equalization system 26 of the present invention is illustrated as mounted between the tires 16 and 18. Suitable connections to the valves of the tires 16 and 18 with the tire pressure equalization system 26 can be made in a conventional manner. The tire pressure equalization system 26 can be suitably mounted to the wheels associated with one or both of the tires 16 and 18 of the dual tire arrangement 12. As such, the tire pressure equalization system 26 will rotate correspondingly with the rotation of the tires 16 and 18.

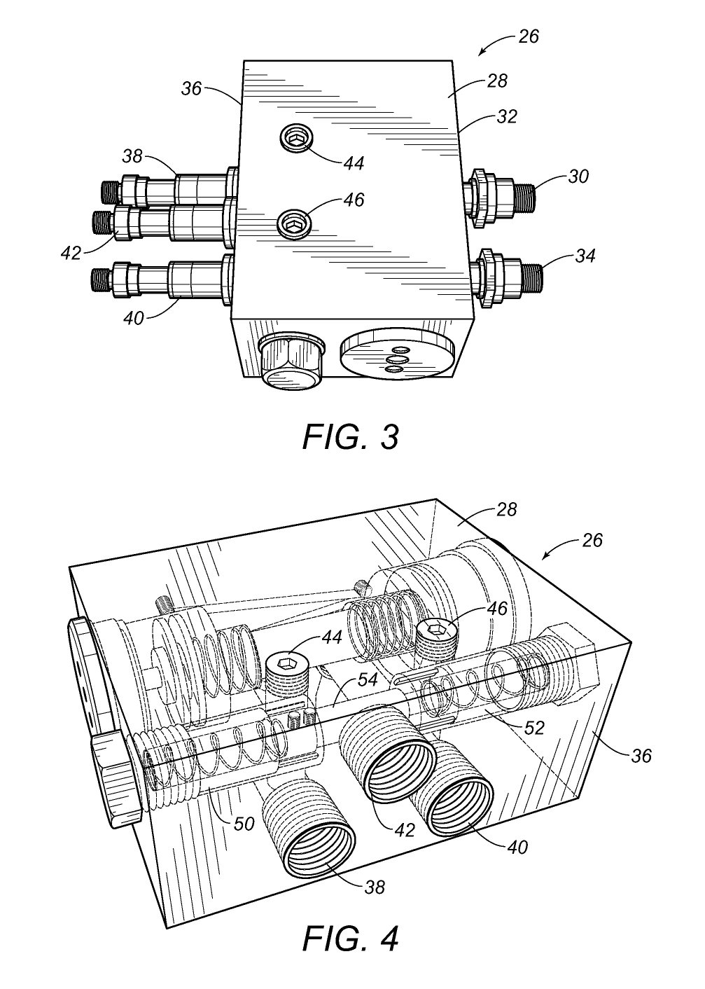

FIG. 3 illustrates the tire pressure equalization system 26 in accordance with the teachings of the present invention. As can be seen, the tire pressure equalization system 26 includes a housing 28 in the form of a box. The housing 28 can be a steel block with suitable air passageways, air channels, bores, and cylindrical areas formed therein. It can be seen that there is a first air passageway 30 extending outwardly from side 32 of the housing 28. A second air passageway 32 extends outwardly from the side 32 of the housing 28. The first air passageway 30 is suitable for connection to a first tire of the dual tire set. The second air passageway 34 is suitable for connection to a second tire of the dual tire set.

The housing 28 includes an opposite side 36. As can be seen, there is a first air channel 38, a second air channel 40 and a third air channel 42 extending outwardly from the side 36. The first air channel 38 is suitable for inflation of the first tire. The second air channel 40 is suitable for inflation of the second tire. The third air channel 42, as will be described hereinafter, is communication with the first air channel 38 and the second air channel 40 so as to simultaneously inflate each of the first tire and the second tire. A first air pressure sensor 44 and a second air pressure sensor 46 are in cooperative with the first air channel 38 and the second air channel 40, respectively. The air pressure sensors 44 are suitable for electronically monitoring air pressure of the first tire and the second tire.

FIG. 4 illustrates an interior view of the tire pressure equalization system 26 of the present invention. In FIG. 4, the side 36 of the housing 28 is particularly illustrated. In particular, the first air channel 38, the second air channel 40 and the third air channel 42 are illustrated as having an end opening at side 36. The fittings illustrated in FIG. 3 are suitable for joining at the connections at the side 36. A first one-way valve 50 is in communication with the first air channel 38. A second one-way valve 52 is cooperative with the second air channel 40. As such, when air is introduced into the first air channel 38, the pressure of the air will suitably open the one-way valve 50 so as to allow air to be transmitted to the first tire. Similarly, when air pressure is introduced into the second air channel 40, the second one-way valve 52 will suitably open so as to allow air to pass through the second air channel 40 to the tire. Once a desired amount of air pressure is received in each of the first and second tires, as monitored by the pressures sensors 44 and 46, the one-way valves 50 and 52 will suitably close so as to prevent air from the respective tires.

The third air channel 42 is communication with the first air channel 38 and the second air channel 40. The third air channel 42 is connected by conduit 44 to each of the first air channel 38 and the second air channel 40. If it is desired to simultaneously inflate both the first tire and the second tire, air pressure can be introduced into the third air channel 42. This will cause the one-way valves 50 and 52 to suitably open so as to allow air flow to pass through the air channels 38 and 40 and into the tires. If the third air channel 42 is not used, then the valves 50 and 52 will suitably close the channels 38 and 40 so as to prevent air from flowing from the tires outwardly of the third air channel 42.

The first air pressure sensor 44 is illustrated as connected to the first air channel 38. The second air pressure sensor 46 is illustrated as connected to the second air channel 40. The pressure sensors 44 and 46 are mounted downstream of the respective one-way valves 50 and 52. As such, the air pressure sensors 44 and 46 continuously monitor air pressure within the tires.

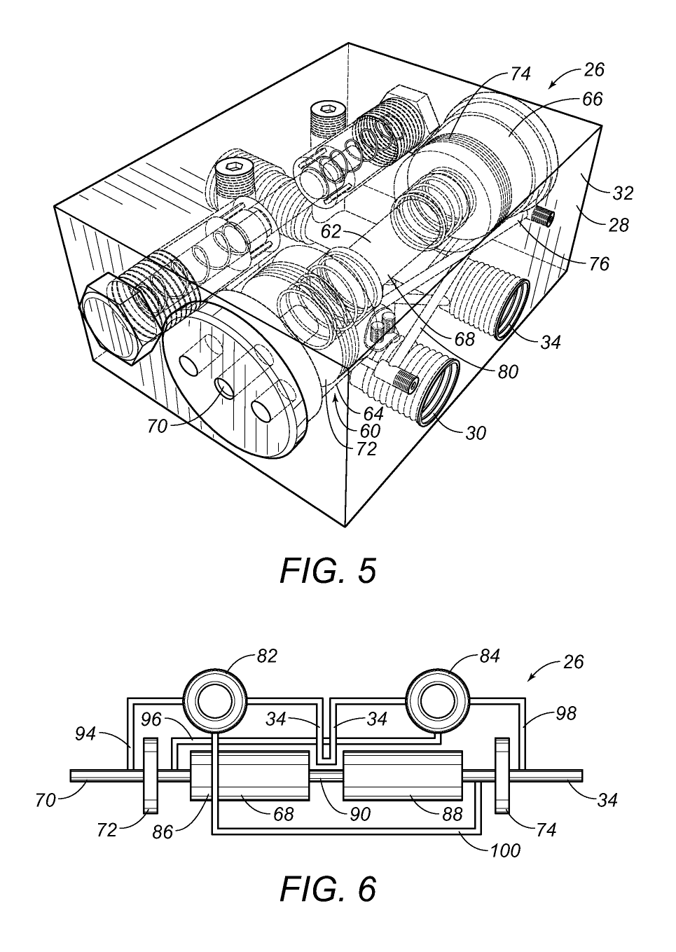

FIG. 5 is a transparent perspective view of the tire pressure equalization system 26 of the present invention. In particular, the structure of the present invention adjacent to the side 36 of the housing 28 is particularly illustrated. As can be seen, the first air passageway 30 and the second air passageway 34 are particularly illustrated. The fittings, as shown in FIG. 3, are omitted in FIG. 4. It can be seen that the openings associated with the air passageways 30 and 34 are suitably threaded so as to accommodate the respective fittings shown in FIG. 3.

FIG. 5 shows that there is a valve arrangement 60. In particular, a bore 62 is illustrated. The bore 62 extends through the housing 28. A first cylindrical area 64 is formed at one end of the bore 62. A second cylindrical area 66 is formed at the opposite end of the bore 62. Importantly, a shuttle valve 68 is positioned in the bore 62.

In FIG. 5, it can be seen that the shuttle valve 68 is generally positioned centrally within the bore 62. A first rod 70 extends from one end of the shuttle valve 68. Another rod extends from the opposite end of the shuttle valve 68. Rod 70 extends through the cylindrical area 64. The other rod will extend through the cylindrical area 66. A first piston 72 is connected to the rod 70 and extends within the cylindrical area 64 so as to have an outer periphery adjacent to the inner wall of the cylindrical area 64. Similarly, a piston 74 is connected to the other rod that extends from the valve 68 and is positioned within the cylindrical area 66. The piston 64 has a periphery adjacent to the inner wall of the piston 66. As will be described hereinafter, the movement of the shuttle valve 68 allows air flow between the air passageways 30 and 34 so as to equalize pressure between the tires or serves to block flow between the air passageways 30 and 34 so as to prevent air from flowing from one tire to the other tire. Suitable air passageways, such as air passageways 76 and 80, also extend between the cylindrical areas 64 and 66 to the tires to further equalize pressure that occurs between the tires and serves to prevent any possible leakage of air from one tire to a deflated tire. The operation of the structure will be described hereinafter.

FIG. 6 is a diagrammatic illustration of the tire pressure equalization system 26 of the present invention. In particular, in FIG. 6, it can be seen that there is first tire 82 and a second tire 84. The shuttle valve 68 is illustrated in FIG. 6 as having a first wide diameter portion 86 and a second wide diameter portion 88. A narrow diameter portion 90 extends between the wide diameter portions 86 and 88. The shuttle valve 68 has the first rod 70 extending outwardly from one end thereof. Piston 72 is affixed to the first rod 70. The second rod extends outwardly from an opposite end of the shuttle valve 68. Piston 74 is connected to the second rod 92.

In FIG. 6, it can be seen that the narrow diameter portion 90 is centrally positioned. As such, the flow passageway 30 will communication with the flow passageway 34 so as to allow for the equalization of pressure between the tires 82 and 84. A third air passageway 94 has an end opening to an interior of the first cylindrical area 64 on one side of the piston 72 opposite the valve 68. The third air passageway 94 is suitably connected to the first tire 82. A fourth air passageway 96 has an end opening to the interior of the first cylindrical area 64 on a side of the first piston 72 opposite the third air passageway 94. This fourth air passageway 96 is connected to the second tire 84. A fifth air passageway 98 has an end opening to an interior of the second cylindrical area 66 on a side of the second piston 74 opposite the valve 68. The fifth air passageway 98 is connected to the second tire 84. A sixth air passageway 100 is illustrated as having an end opening to the interior of the second cylindrical area 66 on a side of second piston 74 opposite to the fifth air passageway 98. The sixth air passageway 100 is connected to the first tire 82. In this arrangement, it can be seen that air pressures are effectively balanced between the first tire 82 and the second tire 84. Ultimately, if one of the tires 82 or 84 becomes deflated or rapidly loses air pressure, the valve 68 will move so that one of the wide diameter portions 86 or 88 moves adjacent to the first air passageway 30 and the second air passageway 34 so as to block air flow between the first tire 82 and second tire 84.

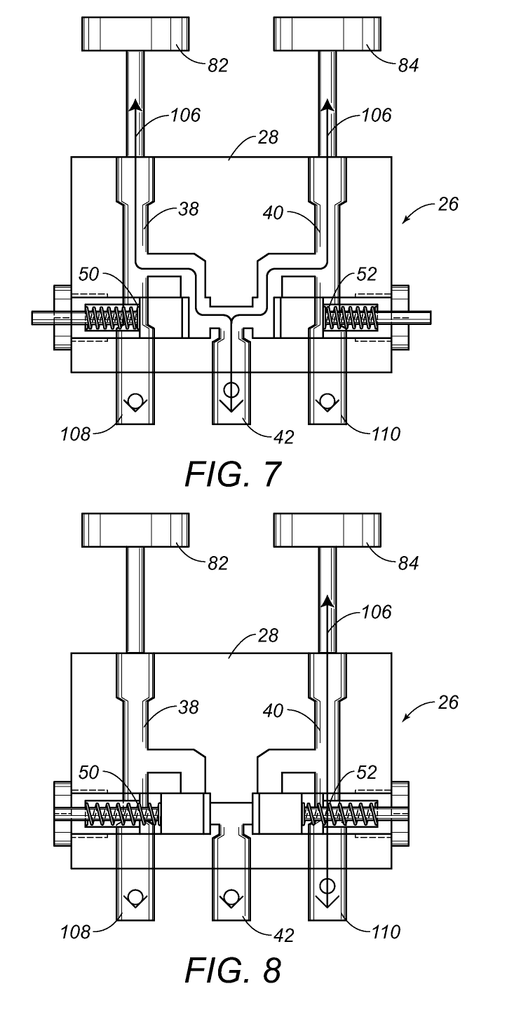

FIG. 7 illustrates the simultaneous filling of the first tire 82 and the second tire 84 using the tire pressure equalization system 26 of the present invention. In particular, in FIG. 7, the third air channel 42 has a source of air pressure connected thereto. The air pressure will flow in accordance with the direction of line 106. It an be seen that the air will flow through the third channel 42 and past the respective valves 50 and 52. The pressure of the air entering the third channel 42 is sufficient so as to open the valves 50 and 52 to allow air to flow from the third channel 42 and through the interior of the housing 28 through the first air channel 38 and the second air channel 40. Air flow through the inlet 108 of the first air channel 38 and the inlet 110 of the second air channel 40 is blocked by the operation of the one-way valves 50 and 52.

In FIG. 7, it is shown that the simultaneous filling of the tires 82 and 84 can be accomplished through a single air source with the third air channel 42. If both tires 82 and 84 have proper integrity, then this filling can be accomplished in a simple and convenient manner. The air pressure entering each of the tires 82 and 84 is effectively balanced in this manner. Once the source of air pressure is disconnected from the third air channel 42, the tires 82 and 84 should be filled with an identical amount of pressure.

FIG. 8 illustrates that the pressurizing of the second tire 84 can be accomplished separate from the filling of the tire 82. In particular, air is introduced through the inlet 110 of the second air channel 40. The air can flow pass the one-way valve 52 and directly to the tire 84. As such, if the tire 84 is deflated substantially or needs to be inflated directly, then a source of pressurized air can be applied to the inlet 110 and the valve 52 will open so as to allow air only to introduced into the second tire 84. The valve 50 associated with the first air channel 38 is closed so as to avoid any release of air pressure from the first tire 82. The valves 50 and 52 are suitably closed so as to prevent any flow of air from the air channels 38 and 40 and the respective tires 82 and 84 outwardly through the third channel 42.

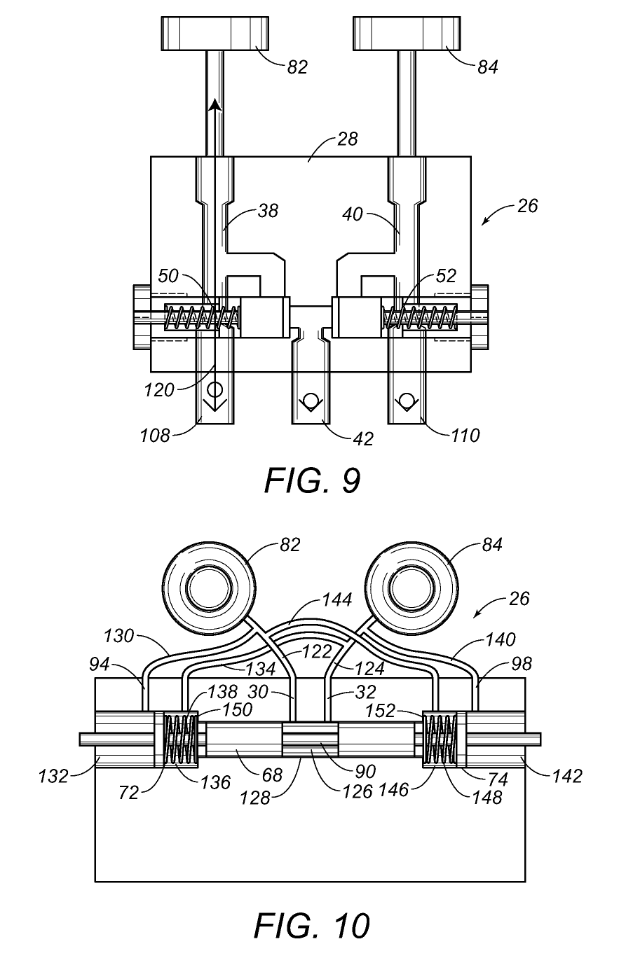

FIG. 9 shows the filling of the first tire 82 with the tire pressure equalization system 26 of the present invention. In FIG. 9, it can be seen that there is a source of pressurized air 120 applied to the inlet 108 of the first air channel 38. The valve 50 is suitably opened so as to allow the air 120 to flow directly to the first tire 82. The valve 52 is suitably closed so as to prevent any release of air pressure from the tire 84 through the second channel 40. Similarly, the valves 50 and 52 operate so as to prevent any loss of air pressure from either of the tires 82 and 84 through the third channel 42. As such, if the first tire 82 should be sufficiently deflated or if a new tire is installed and needs to be separately inflated, then the source of air pressure can be applied to the inlet 108 of the first air channel 38 so as to directly inflate the tire 82.

FIG. 10 is an illustration showing the tire pressure equalization system 26 in which the air pressures of the each of the tires 82 and 84 is equalized. It can be seen that the tire 82 is connected along line 122 to the first air passageway 30. Similarly, the second tire 84 is connected along line 124 to the second air passageway 34. The narrow diameter portion 90 of the valve 68 is positioned in alignment with the air passageways 30 and 32. As such, air will flow from the tires 82 and 84 into the space 126 within the bore 128 so as to equalize therein. The first tire 82 is shown as connected by a line 130 to the third air passageway 34 so as to introduce air into the space 132 on a side piston 72. Similarly, air flows through line 134 into a space 136 on the opposite side of the piston 72. Since the pressure is equalized, the spring 138 is suitably compressed and positioned so as to resiliently maintain the narrow diameter portion 90 of the valve 68 in alignment with the first air passageway 30 and the second air passageway 32.

The fifth air passageway 98 is shown by connected by line 140 to the second tire 84. As such, air, under pressure, will fill the space 142 on the side of the piston 74. Air from the first tire 82 will flow through line 144 into the space 146 on the opposite side of the piston 74. As such, the spring 148 is suitably compressed so as to be balanced such that the narrow diameter portion 90 of the valve 68 resides in alignment with the first air passageway 30 and the second air passageway 32.

As can be seen in FIG. 10, the spring 138 has an end bearing against a shoulder 150 adjacent to the bore 128. The spring 138 will also have an opposite end bearing on the piston 72. The spring 148 has an end bearing against the shoulder 152 and an opposite end bearing against the piston 74. When ever the air pressures are properly balanced, then the amount of force on one side of each of the pistons and the opposite sides each of the pistons will be equal. As such, the valve 68 will be centrally positioned within the bore 128 so as to assure the equalization of pressure between the tires 82 and 84.

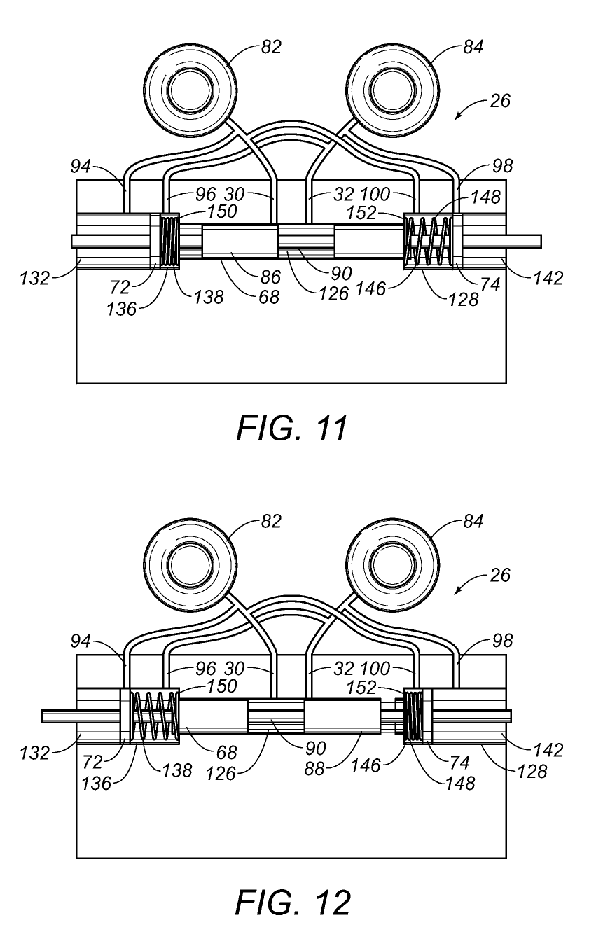

FIG. 11 shows the action of the valve 68 in the event of a loss a air pressure in the second tire 84. As can be seen, the wide diameter portion 86 of the valve 68 is moved directly over the first air passageway 30. As such, this prevents air flow from passing outwardly from the tire 82 into the bore 128 and in a direction toward the deflating second tire 84. Whatever air pressure remains in the deflating tire 84 will pass through the air passageway 32 and into the space 126 at the narrow diameter portion 90 of the valve 68. As such, there is no further leakage of air pressure through the air pressure equalization system 26 of the present invention. Since the tire 82 is at full pressure, the pressurized air will pass through the third air passageway 94 and into the space 132. This serves to urge the piston 72 in a direction toward the valve 68 and to compress the spring 136. Since there is less pressure passing through the fourth air passageway 96, there will be less resistance to the movement of the piston 72 and, as such, the wide diameter portion 86 of the valve 64 will be moved so as to be positioned over the first air passageway 30. Similarly, the reduced air pressure of the tire 84 will cause less air to pass through the fifth air passageway 98 and into the space 142. As such, the spring 148 will serve to urge the piston 74 backwardly. Fundamentally, the air pressure introduced from the first tire 82 into the sixth air passageway 100 will further cause the movement of the piston 74 away from the valve 68. In this manner, the tire 84 can deflate without any deflation in the first tire 82. The pressure within the first tire 82 is effectively maintained until the tire 84 can be suitably repaired.

FIG. 12 shows the situation in which the first tire 82 begins to deflate. The pressure of the tire 84 is maintained to its full extent. In this circumstance, the wide diameter portion 88 of the valve 68 has moved so as to block air from passing into the second air passageway 34. As such, the air pressure in the tire 84 is preserved. The deflating air can flow into the space 126 at the narrow diameter portion 90 of the valve 68 through the first air passageway 30. The spring 138 exerts pressure on the piston 72 so as to urge the piston away from the valve 68. Additionally, the air flowing through the third air passageway 94 is of lesser pressure such that the higher air pressure within the space 136 will cause the movement of the piston 72 toward the third air passageway 94. Similar action occurs with respect to the fifth air passageway 98 and the sixth air passageway 100. Once again, as described in association with FIG. 11, the air pressure within the tire 84 is maintained while the pressure in the tire 82 continues to deflate. As a result, repairs can be easily carried out without the loss of air pressure to the tire 84.

The foregoing disclosure and description of the invention is illustrative and explanatory thereof. Various changes in the details of the illustrated construction can be made within the scope of the appended claims without departing from the true spirit of the invention. The present invention should only be limited by the following claims and their legal equivalents.

I claim:

1. A tire pressure equalization system for controlling air pressure between a first tire and a second tire, the system comprising:
a housing having a bore extending therethrough;
a first air passageway having an end opening to an interior of said bore, said first air passageway suitable for connection to the first tire;
a second air passageway having an end opening to an interior of said bore, said second air passageway suitable for connection to the second tire; and
a valve positioned in said bore, said valve movable between a first position in which said first air passageway communicates with said second air passageway in said bore and a second position blocking communication between said first air passageway and said second air passageway.

2. The system of claim 1, said valve being slidably positioned in said bore.

3. The system of claim 1, said valve being a shuttle valve having a wide diameter portion and a narrow diameter portion, said wide diameter portion being juxtaposed against a wall of said bore, said narrow diameter portion being aligned with said first and second air passageways in said first position, said wide diameter portion being aligned with at least one of said first and second air passageways in said second position.

4. The system of claim 1, said housing having a first cylindrical area at one end of said bore and a second cylindrical area at an opposite end of said bore, said valve having a first rod extending through said first cylindrical area and a second rod extending through said second cylindrical area.

5. The system of claim 4, further comprising:
a first piston affixed to said first rod and having a periphery adjacent a wall of said first cylindrical area; and
a second piston affixed to said second rod and having a periphery adjacent a wall of said second cylindrical area.

6. The system of claim 5, said first cylindrical area having a shoulder adjacent said bore, said second cylindrical area having a shoulder adjacent said bore, the system further comprising:
a first spring having one end bearing against said first piston and an opposite end bearing against said shoulder of said first cylindrical area; and
a second spring having one end bearing against said second piston and an opposite end bearing against said shoulder of said second cylindrical area.

7. The system of claim 5, further comprising:
a third air passageway having an end opening to an interior of said first cylindrical area on a side of said first piston opposite said valve, said third air passageway suitable for connection to the first tire;
a fourth air passageway having an end opening to an interior of said first cylindrical area on a side of said piston opposite said third air passageway, said fourth air passageway suitable for connection to the second tire;
a fifth air passageway having an end opening to an interior of said second cylindrical area on a side of said second piston opposite said valve, said fifth air passageway suitable for connection to the second tire; and
a sixth air passageway having an end opening to an interior of said second cylindrical area on a side of said second piston opposite said fifth air passageway, said sixth air passageway suitable for connection to the first tire.

8. The system of claim 1, further comprising:
a first air channel having one end opening on one side of said housing and an opposite end suitable for connection to the first tire; and
a second air channel having a one end opening on one side of the said housing and an opposite end suitable for connection to the second tire.

9. The system of claim 8, further comprising:
a third air channel opening on said one side of said housing, said third air channel being in communication with said first air channel and said second air channel.

10. The system of claim 8, further comprising:
a first one-way valve positioned on said first air channel so as to allow air to pass through said first air channel to the first tire and for preventing air from passing from the first tire; and
a second one-way valve positioned in said second air channel so as to allow air to pass through said second air channel to the second tire and for preventing air from passing from the second tire.

11. The system of claim 8, further comprising:
a first air pressure sensor cooperative with said first air channel so as to sense air pressure in the first tire; and
a second air pressure sensor cooperative with said second air channel so as to sense air pressure in the second tire.

12. An apparatus comprising:
a first tire;
a second tire;
a housing having a bore extending therethrough;
a first air passageway having a end opening to an interior of said bore, said first air passageway connected to the first tire;
a second air passageway having an end opening to an interior of said bore, said second air passageway connected to the second tire; and
a valve positioned in said bore, said valve movable between a first position in which said first air passageway communicates with said second air passageway in said bore so as to equalize pressures between said first tire and said second tire, and a second position blocking communication between said first air passageway and said second air passageway so as to prevent air from flowing from one of said first and second tires to the other of said first and second tires.

13. The apparatus of claim 12, said first tire fixedly connected to said second tire such that said first and second tires rotate correspondingly.

14. The apparatus of claim 12, said housing fixedly connected between said first and second tires.

15. The apparatus of claim 12, further comprising:
a truck having an axle, said first and second tires being co-axially mounted on said axle.

16. The apparatus of claim 12, said valve being a shuttle valve having a wide diameter portion and a narrow diameter portion, said wide diameter portion being positioned against a wall of said bore, said narrow diameter portion being aligned with said first and second air passageways in said first position, said wide diameter portion being aligned with at least one of said first and second air passageways in said second position.

17. The system of claim 12, said housing having a first cylindrical area at one end of said bore and a second cylindrical area at an opposite end of said bore, said valve having a first rod extending through said first cylindrical area and a second rod extending through said second cylindrical area, the system further comprising;
a first piston affixed to said first rod and having a periphery adjacent a wall of said first cylindrical area; and
a second piston affixed to said second rod and having a periphery adjacent a wall of said second cylindrical area.

18. The apparatus of claim 17, said first cylindrical area having a shoulder adjacent said bore, said second cylindrical area having a shoulder adjacent said bore, the apparatus further comprising:
a first spring having one end bearing against said first piston and an opposite end bearing against said shoulder of said first cylindrical area; and
a second spring having one end bearing against said second piston and an opposite end bearing against said shoulder of said second cylindrical area.

19. The apparatus of claim 17, further comprising:
a third air passageway having an end opening to an interior of said first cylindrical area on a side of said first piston opposite said valve, said third air passageway connected to the first tire;
a fourth air passageway having an end opening to an interior of said first cylindrical area on a side of said piston opposite said third air passageway, said fourth air passageway connected to the second tire;
a fifth air passageway having an end opening to an interior of said second cylindrical area on a side of said second piston opposite said valve, said fifth air passageway connected to said second tire; and
a sixth air passageway having an end opening to an interior of said second cylindrical area on a side of said second piston opposite said fifth air passageway, said sixth air passageway connected to the first tire.

20. The apparatus of claim 12, further comprising:
a first air channel having one end opening on one side of said housing and an opposite end connected to the first tire;
a second air channel having an end opening on one side of the said housing and an opposite end connected to said second tire;
a third air channel opening on said one side of said housing, said third air channel being in communication with said first air channel and said second air channel;
a first one-way valve positioned on said first air channel so as to allow air to pass through said first air channel to the first tire and for preventing air from passing from the first tire; and
a second one-way valve positioned in said second air channel so as to allow air to pass through said second air channel to the second tire and preventing air from passing from the second tire.
